(19) United States
(12) Patent Application Publication
(10) Pub. No.: US 2024/0018173 A1
(43) Pub. Date: Jan. 18, 2024

(54) PROCESS FOR PREPARING PHOSPHONATE ESTERS

(71) Applicant: ENTEGRIS, INC., Billerica, MA (US)

(72) Inventors: Adrian Houghton, Toronto (CA); Scott A. Laneman, Vernon Hills, IL (US)

(21) Appl. No.: 18/219,447

(22) Filed: Jul. 7, 2023

Related U.S. Application Data
(60) Provisional application No. 63/389,718, filed on Jul. 15, 2022.

(51) Int. Cl. C07F 9/40

(52) U.S. Cl. CPC C07F 9/409

(57) ABSTRACT

Provided is a process for the preparation of certain bisphosphonate compounds and their ester derivatives. In this process certain bisphosphonate compounds such as medronic acid is prepared via the reaction of the corresponding isopropyl esters with (i) trimethylsilylbromide or trimethylsilyl iodide, or (ii) trimethylsilyl chloride and an alkali metal iodide or bromide; followed by treatment with a liquid comprising water. The process surprisingly provides the desired compounds, despite having relatively bulky ester groups such as isopropyl on the starting material bisphosphonate ester.

### TECHNICAL FIELD

The disclosure belongs generally to the field of synthetic organic chemistry. In particular, it relates to a process for preparing medronic acid, which can be further derivatized to its corresponding esters.

### BACKGROUND

Medronic acid, CAS No. 1984-15-2, is a useful diphosphonate compound, which has been used in a complex with radioactive technetium in nuclear medicine procedures. Known processes generally suffer from low yields and involve the use of air and moisture sensitive reagents.

### SUMMARY

In summary, the disclosure provides a process for the preparation of certain bisphosphonate compounds and their ester derivatives. In this process certain bisphosphonate compounds such as medronic acid (where z is 1 below) is prepared via the reaction of the corresponding isopropyl esters with (i) trimethylsilylbromide or trimethylsilyl iodide, or (ii) trimethylsilyl chloride and an alkali metal iodide or bromide; followed by treatment with a liquid comprising water. The process surprisingly provides the desired compounds, despite having relatively bulky ester groups such as isopropyl on the starting material bisphosphonate ester.

### DETAILED DESCRIPTION

As used in this specification and the appended claims, the singular forms “a”, “an”, and “the” include plural referents unless the content clearly dictates otherwise. As used in this specification and the appended claims, the term “or” is generally employed in its sense including “and/or” unless the content clearly dictates otherwise.

The term “about” generally refers to a range of numbers that is considered equivalent to the recited value (e.g., having the same function or result). In many instances, the term “about” may include numbers that are rounded to the nearest significant figure.

Numerical ranges expressed using endpoints include all numbers subsumed within that range (e.g., 1 to 5 includes 1, 1.5, 2, 2.75, 3, 3.80, 4 and 5).

In a first aspect, the disclosure provides a process for preparing a compound of the Formula (I)

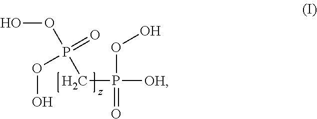

wherein z is an integer of from 1 to 12, which comprises contacting a compound of the Formula (A)

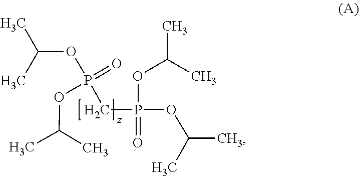

with (i) trimethylsilylbromide or trimethylsilyl iodide, or (ii) trimethylsilyl chloride and an alkali metal iodide or bromide; followed by treatment with a liquid comprising water.

In the process, compounds of the Formula (A) are commercially available. For example, when z is 1, the CAS No. is 1660-95-3, and is available from Sigma Aldrich. Exemplary alkali metal iodides or bromides include sodium iodide, potassium iodide, sodium bromide, and potassium bromide. When trimethylsilyl bromide or iodide is utilized, the process is generally conducted at elevated temperatures, for example about 60-80° C. When a combination of trimethylsilyl chloride and an alkali metal iodide is utilized, the process can be conducted at room temperature up to about 70° C. In addition, a compound of the Formula (A) may be reacted with (ii) trimethylsilyl chloride and an iodide or bromide of Groups II or X (for example MgBr₂, NiI₂, etc.).

In either case, generally polar aprotic solvents can be utilized, such as acetonitrile or dichloroethane.

In the second step above, a trimethylsilyl phosphate ester intermediate is hydrolyzed in situ with a liquid comprising water, for example water containing alcohol(s). In one embodiment, the trimethylsilyl phosphate ester is treated with water at room temperature.

In a further aspect, the disclosure provides a process wherein the compound of Formula (I) is treated further with an alkylating compound of the formula HC(OR)₃, wherein R is a primary or secondary C₁-C₈ alkyl group, to form a compound of the Formula (II):

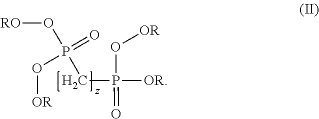

In this aspect, suitable alkylating agents include trimethyl orthoformate, triethyl orthoformate, tri(n-octyl) orthoformate, and the like.

Existing methodology for producing compounds of Formula (I) include treatment of a compound of Formula (A) with phosphorous pentachloride (PCl₅), to yield a tetra-chlorinated intermediate which is in turn reacted with an alcohol in the presence of an amine such as triethylamine. In this existing process, phosphoryl chloride (POCl₃) is generated in situ. Advantageously, the process of the disclosure does not utilize phosphorous pentachloride. Accordingly, the process provides compounds of Formula (I) (and compounds of Formula (II)) which are in one embodiment, essentially free of contaminants of the formula PO(OR)₃, and their partially-chlorinated counterparts. In certain embodiments, the compounds of Formula (I) and (II) possess less than about 1000 ppm of PO(OR)₃, less than about 700 ppm of PO(OR)₃, less than about 500 ppm of PO(OR)₃, less than about 250 ppm of PO(OR)₃, less than about 100 ppm of PO(OR)₃, less than about 75 ppm of PO(OR)₃, less than about 50 ppm of PO(OR)₃, less than about 25 ppm of PO(OR)₃, or less than about 10 ppm of PO(OR)₃. In this regard, PO(OR)₃ can be measured by HPLC (high performance liquid chromatography).

### EXAMPLES

General Procedures:

All manipulations were performed under an inert atmosphere unless otherwise stated. NMR analyses were performed in air. NMR measurements were carried out on a Bruker 400 MHz

Diphosphonic Acid Syntheses

### Example 1

A 250 mL 3-neck round-bottom flask was charged with tetraisopropyl methylene diphosphonate (36 mL, 112 mmol) and heated to 50° C. Bromotrimethylsilane (70 mL, 530 mmol) was added and the mixture heated to 75° C. for 2 hours. The mixture was cooled to 30 C and the volatiles removed in vacuo. Analysis of the mixture by NMR showed complete conversion to the intermediate tetrakis(trimethylsilyl) methylene diphosphonate. ¹H NMR (400 MHz, CDCl₃): δ=2.29 (t (br), 2H, ²J_{PH}=21 Hz, CH₂), 0.27 (s (br), 36H, SiCH₃). ¹³C{¹H} NMR (100 MHz, neat): 30.58 (t, ¹J_{PC}=139.7 Hz, CH₂), 1.04 (s, SiCH₃). ³¹P{¹H} NMR (162 MHz, neat): δ=2.29 (br).

Water was added to the mixture and stirred for 1 hour at ambient temperature. The layers were allowed to separate and the organic layer discarded. The water was removed by trituration with isopropanol (4×30 mL), then filtered and washed with more isopropanol (20 mL) and dried in vacuo to give a white powder (18.3 g, 92% yield). ¹H NMR (400 MHz, D₂O): δ=2.29 (t 2H, ²J_{PH}=21 Hz, CH₂). ¹³C{¹H} NMR (100 MHz, D₂O): δ=26.9 ppm (t, ¹J_{CP}=130 Hz). ³¹P{¹H} NMR (162 MHz, neat): δ=18.1 ppm. Purity by ³¹P{¹H} assay was 99.8%. Purity by ¹H assay was 98.0%

### Example 2

A flask is charged with a slurry of NaI (4.5 eq) in dichloroethane (20 mL). Tetraisopropyl methylene diphosphonate (5.0 mL, 15.6 mmol) is added at 50° C., followed by trimethylsilyl chloride (TMSCl) (9.0 mL 4.5 eq). The mixture is stirred for 24 hours at 70° C., cooled to room temperature, filtered, and washed with dichloroethane (2×20 mL). The volatiles are then removed under vacuum. From here the workup is carried out in the same fashion as in Example 1 following the addition of water. Obtained medronic acid in 21% yield. The low yield is attributed to the air sensitivity of the tetrakis(trimethylsilyl) methylene diphosphonate intermediate, as a gummy solid formed during the initial filtration.

### Example 3

A flask is charged with a slurry of LiI (9.4 g, 4.5 eq) in DCE (20 mL). Tetraisopropyl methylene diphosphonate (5.0 mL, 15.6 mmol) is added at 50° C., followed by TMSCl (9.0 mL 4.5 eq). The mixture is stirred for 50 hours at 70° C., cooled to room temperature, diluted further with DCE (20 mL), filtered under nitrogen, and washed with DCE (3×10 mL). The volatiles are then removed under vacuum at 60° C. From here the workup is carried out in the same fashion as in Example 1 following the addition of water. Obtained medronic acid in 89% yield.

### Example 4

A flask is charged with a slurry of KBr (8.4 g, 4.5 eq) in DCE (20 mL). Tetraisopropyl methylene diphosphonate (5.0 mL, 15.6 mmol) is added at 50° C., followed by TMSCl (9.0 mL 4.5 eq). The mixture is stirred for 50 hours at 70° C., After which 31P NMR (D₂O) indicated 77% conversion to medronic acid (based on —OiPr groups converted to —OH). The mixture was discarded.

### Example 5

A flask is charged with a slurry of KI (11.6 g, 4.5 eq) in MeCN (20 mL). Tetraisopropyl methylene diphosphonate (5.0 mL, 15.6 mmol) is added at 50° C., followed by TMSCl (9.0 mL 4.5 eq). The mixture is stirred for 21 hours at 50° C., cooled to room temperature, diluted further with DCM (40 mL), filtered under nitrogen, and washed with DCM (3×10 mL). The volatiles are then removed under vacuum at 60° C. From here the workup is carried out in the same fashion as in Example 1 following the addition of water. Obtained medronic acid in 77% yield.

### Example 6

A flask is charged with a slurry of MgBr₂ (6.3 g, 2.2 eq) in MeCN (20 mL). Tetraisopropyl methylene diphosphonate (5.0 mL, 15.6 mmol) is added at 50° C., followed by TMSCl (9.0 mL 4.5 eq). The mixture is stirred for 24 hours at 70° C., then more MgBr₂ (1.1 eq) and TMSCl (2.25 eq) were added. After a total of 65 hours at 70° C. ³¹P NMR (D₂O) showed that the complex mixture contained only 6% medronic acid (confirmed by spiking) by assay. The mixture was discarded.

### Example 7

A flask is charged with a slurry of ZnI₂ (11.9 g, 2.4 eq) in MeCN (20 mL). Tetraisopropyl methylene diphosphonate (5.0 mL, 15.6 mmol) is added at 50° C., followed by TMSCl (9.0 mL 4.5 eq). The mixture is stirred for 43 hours at 70° C., after which ³¹P NMR (D₂O) indicated 98% conversion to medronic acid (based on —OiPr groups converted to —OH).

### Example 8

A flask is charged with a slurry of CaI₂ (5.5 g, 2.4 eq) in MeCN (20 mL). Tetraisopropyl methylene diphosphonate (5.0 mL, 15.6 mmol) is added at 50° C., followed by TMSCl (9.0 mL 4.5 eq). The mixture is stirred for 43 hours at 70° C., after which 31P NMR (D₂O) showed that the complex mixture contained only 8.8% medronic acid (confirmed by spiking) by assay. The mixture was discarded.

### Example 9

A procedure identical to Example 1 is carried out using tetraethyl ethylene diphosphonate. Obtained 1,2-ethylenediphosphonic acid in 53% yield (0.65 g). ¹H (400 MHz, D₂O): δ=1.84 (m, 4H). ¹³C{¹H} NMR (100 MHz, D₂O): δ=20.0 ppm (m). ³¹P{¹H} NMR (162 MHz, D₂O): δ=28.4 ppm

### Example 10

A procedure identical to Example 1 is carried out using tetraethyl dodecylene diphosphonate. Obtained 1,12-dodecylenediphosphonic acid in 43% yield (0.65 g). ¹H (400 MHz, MeOH-d₄): δ=1.33-1.73 ppm (m, 24H). ¹³C{¹H} NMR (100 MHz, MeOH-d₄): δ=31.8 (d, ²J_{PC}=16 Hz), 30.7 (s), 30.5 (s), 30.3 (s), 28.2 ppm (¹J_{PC}=138 Hz), 23.9 ppm (³J_{PC}=5.8 Hz). ³¹P{¹H} NMR (162 MHz, MeOH-d₄): δ=30.2 ppm

Diphosphonate Syntheses

### Example 11

Medronic acid (17.4 g, 98.8 mmol) and trimethyl orthoformate (56 mL, 511 mmol) were charged into a 250 mL flask equipped with a stir bar and water-cooled distillation apparatus. The mixture was heated to 90 C for 2 hours, then cooled to 40° C. The distilled byproducts were discarded and another aliquot of trimethyl orthoformate (46 mL, 420 mmol) was added. The stillpot was heated to 100° C., then incrementally to 120° C. over 2.5 hours. After another 1 hour at 120° C., the reaction was complete by ³¹P{¹H} NMR. The distilled byproducts were discarded and all other volatiles removed in vacuo at 60° C. The product was distilled at 110-118° C./540-570 mTorr to give tetramethyl methylene diphosphonate as a clear, colourless liquid (20.4 g, 89.1% yield) ¹H NMR (400 MHz, CDCl₃): δ=3.74 (d, 12H, ³J_{PH}=11 Hz, CH₃), 2.31 (t 2H, ²J_{PH}=21 Hz, CH₂), ¹³C{¹H} NMR (100 MHz, CDCl₃): δ=52.58 (m), 22.92 (t, ¹J_{PC}=136.5 Hz, CH₂) ³¹P{¹H} NMR (162 MHz, CDCl₃): δ=21.9. Purity by ³¹P{¹H} assay was 99.8%. Purity by ¹H assay was 99.1%

### Example 12

Medronic acid (0.50 g, 2.84 mmol) and triethyl orthoformate (10 mL, 21 eq) were combined and heated to 120° C. for 2 days. The volatiles were removed in vacuo at 50° C. to give tetraethyl methylene diphosphonate as a yellow oil in essentially quantitative yield (0.82 g). ¹H NMR (400 MHz, CDCl₃): δ=4.18 ppm, (m, 8H, CH₂—O), 2.44 ppm (2H, t, ²J_{PH}=20.9 Hz), 1.34 ppm (12H, t, J=7.0 Hz), 88% assay. ¹³C{¹H} NMR (100 MHz, CDCl₃): δ=62.5 ppm (m), 25.5 ppm (t, ¹J_{PC}=136 Hz, CH₂), 16.3 (m) ³¹P{¹H} NMR (162 MHz, CDCl₃): δ=19.4 (99.8% assay).

### Example 13

Medronic acid (0.50 g, 2.84 mmol) and triisopropyl orthoformate (13 mL, 20 eq) were combined and heated to 120-140° C. for 3 days after which ³¹P NMR (CDCl₃) indicated 98% conversion to tetraisopropylmethylene diphosphonate.

### Example 14 (Prophetic)

A procedure similar to Example 13 is used, with tributyl orthoformate as the alkylating agent. Achieved 98.5% conversion to tetrabutyl methylene diphosphonate by ³¹P NMR (CDCl₃) ³¹P{¹H} NMR (162 MHz, CDCl₃): δ=19.5

### Example 15

A procedure similar to example 12 is used, with ethylene diphosphonic acid as the substrate. Obtained tetramethylethylene-1,2-diphosphonate as a yellow oil in quantitative yield. ¹H NMR (400 MHz, CDCl₃): δ 3.72 (m, 12H, CH₃), 1.96 (m, 4H, CH₂), 92% assay. ¹³C{¹H} NMR (100 MHz, CDCl₃): δ=52.4 ppm (m, CH₃), 18.0 ppm (m, at) ³¹P{¹H} NMR (162 MHz, CDCl₃): δ=32 (95.2% assay).

### Example 16

A procedure similar to Example 12 is used, with dodecylene diphosphonic acid as the substrate. Obtained tetramethyldodecylene-1,12-diphosphonate as a tacky solid in quantitative yield. ¹H NMR (400 MHz, CDCl₃): δ 3.72 (t, J=5.4 hz, 12H, CH₃), 1.96 (m, 4H, CH₂), 92% assay. ¹³C{¹H} NMR (100 MHz, CDCl₃): δ=52.5 (d, ²J_{PC}=6.6 Hz, CH₃), 30.5 (d, ²J_{PC}=17 Hz), 29.5, 29.3, 29.1, 24.6 (d, ¹J_{PC}=140 Hz, P—CH₂), 22.2 (d, J=5.5 Hz), ³¹P{¹H} NMR (162 MHz, CDCl₃): δ=35.2 (89.8% assay).

### Aspects

In a first aspect, the disclosure provides a process for preparing a compound of the Formula (I)

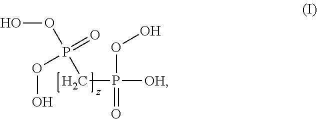

wherein z is an integer of from 1 to 12, which comprises contacting a compound of the Formula (A)

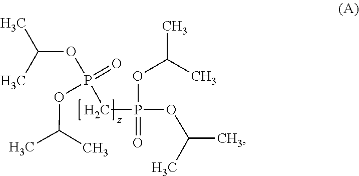

with (i) trimethylsilylbromide or trimethylsilyl iodide, or (ii) trimethylsilyl chloride and an alkali metal iodide or bromide; followed by treatment with a liquid comprising water.

In a second aspect, the disclosure provides the process of the first aspect, wherein the compound of the Formula (A) is reacted with trimethylsilyl bromide or trimethylsilyl iodide.

In a third aspect, the disclosure provides the process of the first aspect, wherein the compound of the Formula (A) is reacted with (ii) trimethylsilyl chloride and an alkali metal iodide or bromide.

In a fourth aspect, the disclosure provides the process of the third aspect, wherein an alkali metal iodide is utilized and is sodium iodide.

In a fifth aspect, the disclosure provides the process of the third aspect, wherein an alkali metal iodide is utilized and is potassium iodide.

In a sixth aspect, the disclosure provides the process of any preceding aspect, wherein the compound of Formula (I) contains less than about 1000 ppm of compounds of the formula PO(OR)₃.

In a seventh aspect, the disclosure provides the process of any preceding aspect, wherein the compound of Formula (I) contains less than about 100 ppm of compounds of the formula PO(OR)₃.

In an eighth aspect, the disclosure provides the process of any preceding aspect, further comprising the step of reacting the compound of the Formula (I) with an alkylating compound of the formula HC(OR)₃, wherein R is a
primary or secondary C₁-C₈ alkyl group, to form a compound of the Formula (II):

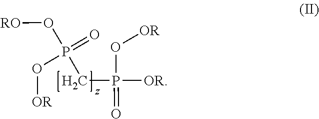

In a ninth aspect, the disclosure provides the process of the eighth aspect, wherein R is chosen from methyl, ethyl, n-pentyl, n-octyl, and isopropyl.

In a tenth aspect, the disclosure provides the process of the eighth aspect, wherein z is 1 and R is methyl.

In an eleventh aspect, the disclosure provides the process of any of the eighth through tenth aspects, wherein the compound of Formula (II) contains less than about 1000 ppm of compounds of the formula PO(OR)₃.

In a twelfth aspect, the disclosure provides the process of any of the eighth through eleventh aspects, wherein the compound of Formula (II) contains less than about 100 ppm of compounds of the formula PO(OR)₃.

In a thirteenth aspect, the disclosure provides a compound of the Formula (I)

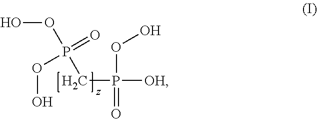

wherein z is an integer of from 1 to 12, prepared by the process of any of the first through seventh aspects.

In a fourteenth aspect, the disclosure provides a compound of the Formula (I)

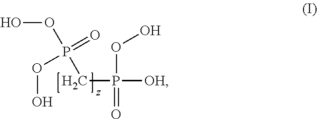

wherein z is an integer of from 1 to 12, and which contains less than about 1000 ppm of compounds of the formula PO(OR)₃.

In a fifteenth aspect, the disclosure provides the compound of the fourteenth aspect which contains less than about 100 ppm of compounds of the formula PO(OR)₃.

In a sixteenth aspect, the disclosure provides the compound of the fourteenth aspect, which contains less than about 10 ppm of compounds of the formula PO(OR)₃.

In a seventeenth aspect, the disclosure provides a compound of the Formula (II):

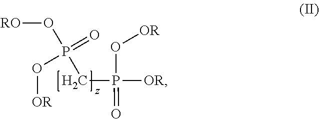

wherein R is a C₁-C₈ primary or secondary alkyl group, and which contains less than about 1000 ppm of compounds of the formula PO(OR)₃.

In an eighteenth aspect, the disclosure provides the compound of the seventeenth aspect which contains less than about 100 ppm of compounds of the formula PO(OR)₃.

In a nineteenth aspect, the disclosure provides the compound of the seventeenth aspect, which contains less than about 10 ppm of compounds of the formula PO(OR)₃.

Having thus described several illustrative embodiments of the present disclosure, those of skill in the art will readily appreciate that yet other embodiments may be made and used within the scope of the claims hereto attached. Numerous advantages of the disclosure covered by this document have been set forth in the foregoing description. It will be understood, however, that this disclosure is, in many respects, only illustrative. The disclosure's scope is, of course, defined in the language in which the appended claims are expressed.

What is claimed is:

1. A process comprising:
contacting a compound of the Formula (A) 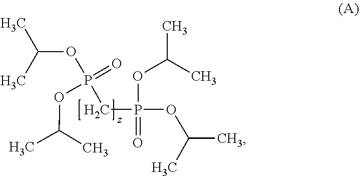
with (i) trimethylsilylbromide or trimethylsilyl iodide, or (ii) trimethylsilyl chloride and an alkali metal iodide or bromide to form a mixture; and
treating the mixture with a liquid comprising water, thereby forming a compound of the Formula (I) 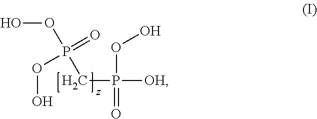
wherein z is an integer of from 1 to 12.

2. The process of claim 1, wherein the compound of the Formula (A) is reacted with trimethylsilyl bromide or trimethylsilyl iodide.

3. The process of claim 1, wherein the compound of the Formula (A) is reacted with trimethylsilyl chloride and an alkali metal iodide or bromide.

4. The process of claim 3, wherein an alkali metal iodide is utilized and is sodium iodide.

5. The process of claim 3, wherein an alkali metal iodide is utilized and is potassium iodide.

6. The process of claim 1, wherein the compound of Formula (I) contains less than about 1000 ppm of compounds of the formula PO(OR)₃.

7. The process of claim 6, wherein the compound of Formula (I) contains less than about 100 ppm of compounds of the formula PO(OR)₃.

8. The process of claim 1, further comprising reacting the compound of Formula (I) with an alkylating compound of the formula HC(OR)₃, wherein R is a primary or secondary C₁-C₈ alkyl group, to form a compound of the Formula (II):

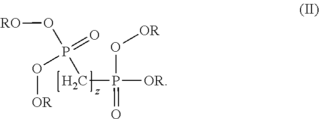

9. The process of claim 8, wherein R is chosen from methyl, ethyl, n-pentyl, n-octyl, and isopropyl.

10. The process of claim 8, wherein z is 1 and R is methyl.

11. The process of claim 9, wherein z is 1 and R is methyl

12. The process of claim 8, wherein the compound of Formula (II) contains less than about 1000 ppm of compounds of the formula PO(OR)₃.

13. The process of claim 8, wherein the compound of Formula (II) contains less than about 100 ppm of compounds of the formula PO(OR)₃.

14. A compound of the Formula (I) 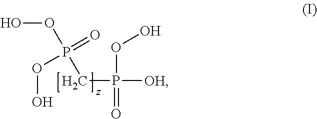
wherein z is an integer of from 1 to 12, prepared by the process of claim 1.

15. A compound of the Formula (I) 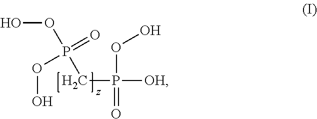
wherein z is an integer of from 1 to 12, and which contains less than about 1000 ppm of compounds of the formula PO(OR)₃.

16. The compound of claim 15, wherein the compound contains less than about 100 ppm of compounds of the formula PO(OR)₃.

17. A compound of the Formula (II): 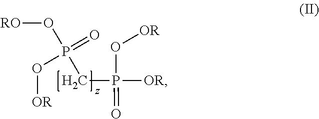
wherein R is a C₁-C₈ primary or secondary alkyl group, and which contains less than about 1000 ppm of compounds of the formula PO(OR)₃.

18. The compound of claim 17, wherein the compound contains less than about 100 ppm of compounds of the formula PO(OR)₃.
